(19) United States
(12) Patent Application Publication
(10) Pub. No.: US 2019/0033486 A1
(43) Pub. Date: Jan. 31, 2019

(54) OPTOELECTRONIC SENSOR

(71) Applicant: SICK AG, Waldkirch (DE)

(72) Inventors: Kai WASLOWSKI, Waldkirch (DE); Ingolf HÖRSCH, Waldkirch (DE); Gerhard MERETTIG, Waldkirch (DE)

(21) Appl. No.: 16/041,078

(22) Filed: Jul. 20, 2018

(30) Foreign Application Priority Data
Jul. 25, 2017 (DE) 102017116828.1

(51) Int. Cl. G01V 8/12

(52) U.S. Cl. CPC G01V 8/12

(57) ABSTRACT

The invention relates to an optoelectronic detector for the detection of objects in a monitored zone that comprises:
a sensor module comprising a light transmitter for transmitting a transmitted light signal into the monitored zone, a light receiver for receiving a light signal from the monitored zone and for generating a corresponding received signal, and a sensor evaluation unit for evaluating the received signal and for generating process data (object determination signal) and for generating sensor module data;
a process data channel for outputting the process data;
a condition monitoring module having a condition evaluation unit for generating condition data; and
a first internal interface between the sensor module and the condition monitoring module for transmitting the sensor module data to the condition monitoring module.

The invention relates to an optoelectronic detector for the detection of objects in a monitored zone.

Optical light sensors, light barriers, through beam sensors, reflection light barriers or the like that typically work in reflection or transmission are e.g. used for the detection of objects in a monitored zone. With a reflection light sensor, the transmitted light signals are reflected by an object that may be located in the monitored zone and the reflected light signals are received by a light receiver so that the presence of an object in the monitored zone is recognized on the basis of the received light signals. With a light barrier, on the absence of an object in the monitored zone, the transmitted light signals are received either directly by a light receiver or via a reflector, with the light signal being interrupted or at least attenuated by an object present in the monitored zone so that the presence of an object in the monitored zone is thereby recognized.

It is the object of the invention to further develop such an optoelectronic detector that it works more reliably and can better detect the situation to be detected.

This object is respectively satisfied by a detector and by a method having in accordance with the respective independent claim.

The optoelectronic detector in accordance with the invention for the detection of objects in a monitored zone comprises:
a sensor module comprising a light transmitter for transmitting a transmitted light signal into the monitored zone, a light receiver for receiving a light signal from the monitored zone and for generating a corresponding received signal, and a sensor evaluation unit for evaluating the received signal and for generating process data (object determination signal) and for generating sensor module data;
a process data channel for outputting the process data;
a condition monitoring module having a condition evaluation unit for generating condition data;
a first internal interface between the sensor module and the condition monitoring module for transmitting the sensor module data to the condition monitoring module;
a circular buffer that receives data comprising the condition data and/or sensor module data from the condition monitoring module via a second interface for temporary storage;
wherein the condition monitoring module is configured to output a first trigger signal via the second interface in dependence on the condition data and/or the sensor module data;
and the first trigger signal prevents a further overwriting of the data in the circular buffer for a defined time period;
and the data from the circular buffer can be output via a condition data channel.

The main idea of the invention is reflected in three key points. First, an additional condition monitoring module is provided so that the sensor cannot only simply satisfy its detection task, but can rather additionally also deliver further data in addition to the process data, that is to the object determination signals. Second, these data can be invoked when they are needed, and third, the additional data can be output via a separate data channel. Provision is made by means of a circular buffer here that the amount of data remains limited and manageable.

In principle, the condition monitoring module can serve for the monitoring of the detection capability of the sensor and for the general monitoring of the detection situation. In an error case, it can serve for the retroactive or proactive error analysis.

Condition monitoring modules are admittedly generally known from mechanical engineering, but only for monitoring large plant, with the condition monitoring modules receiving their data from such optoelectronic sensor as described above. Such singular optoelectronic sensors such as the light barriers and light sensors mentioned above did not have such complex condition monitoring modules. They were previously also not able to cope with the flood of data associated with condition monitoring.

The invention now provides the condition monitoring module that generates the condition data from the sensor module data and temporarily stores the data, condition data and/or sensor module data in a circular buffer. That is, only the current data are stored. Depending on the capacity of the circular buffer, a specific number of data sets can be stored before the oldest data sets are then overwritten with the newest data sets.

In this respect, the data sets are only output as required via a separate condition data channel. The output is initiated by a trigger signal that is e.g. only generated in the error case. A monitoring of the function of the sensor can thus take place. In addition, the condition monitoring module can autonomously generate a trigger by analysis of the sensor module data (when e.g. the outside temperature exceeds a limit value).

Since a condition data set is comparatively extensive as a rule, e.g. it can comprise images of the detection region, the condition data channel is comparatively slow. This is sufficient since the condition data channel is only singularly used for the analysis.

The condition data from the circular buffer that are output over the condition data channel preferably have a time stamp. This substantially facilitates and improves an error analysis.

In a further development of the invention, the sensor evaluation unit is configured to output a second trigger signal to the condition monitoring module via the first interface in dependence on the sensor module data. The sensor evaluation unit can thus trigger an acyclic data recording (snapshot). The assumption that the sensor evaluation unit can itself generate a meaningful trigger is based on the experience that the condition of the environment is actually of interest when the sensor switches on or off. At this moment, the object to be detected enters into interaction with the sensor and is recognized at exactly the right position in the ideal case. In the simplest case, the trigger is released to stop the overwriting in the circular buffer when the object determination signal of the sensor just changes its state.

In a further development of the invention, a trigger signal is output to the circular buffer when one of the following conditions is satisfied:
when the signal progression of the received signal significantly differs from the previous signal progressions;
when the amplitude of the received signal or of the evaluated received signal varies by more than a defined value within a defined time period. An evaluated received signal could be a difference signal for example;
when the amplitude of the received signal or of the evaluated received signal is within a defined value range;
when particularly short switching processes are detected that are so short that they cannot be associated with an object;
when the received signal comes close to a predefined switching threshold;
when the received signal is overmodulated;
when redundant signals show large deviations;
when a contamination of optical components is recognized;
when a dazzling of the light receiver is recognized; or
when the detector recognizes interference by another, adjacent detector of the same construction.

These are typical error conditions whose analysis is greatly improved by the then available condition data. The findings from the analysis are then usable for an improvement and for an avoidance of the error states.

If a quality index can be determined by means of suitable rules from the data, it is advantageous if the condition monitoring module is configured to determine this quality index and to output the first trigger signal when the quality index is in a predefined range. The detection quality can thus be monitored and improved where possible.

A further improved functional analysis of the detector is possible if the data from the circular buffer that are output over the condition data channel include a piece of information on which condition released the trigger signal.

In a further development of the invention, the condition monitoring module is programmable over the condition data channel so that the conditions for the output of the first trigger signal can be predefined and set from outside so that the detector works in accordance with predefined criteria.

For the improved recognition of the detection situation and thus for an improved functional analysis, the detector has third sensors that, for example, detect an environmental temperature, an installation position, a supply voltage, a power loss, a luminous intensity of the room lighting in the field of view of the detector, an acceleration of the detector, the air pressure, an electrical or magnetic field strength, or similar external influences. A third sensor can also be formed by an optical image recorder, a camera, whose image recording is released by the first or second trigger signals. The third sensors are evaluated for generating the trigger signal by the condition monitoring module.

The method in accordance with the invention for the detection of objects in a monitored zone comprises the steps:
transmitting a transmitted light signal by a light transmitter into the monitored zone, receiving a light signal by a light receiver from the monitored zone, and generating a corresponding received signal and evaluating the received signal, generating process data, and generating sensor module data using a sensor data evaluation unit;
outputting the process data over a process data channel;
generating condition data using a condition evaluation unit in a condition monitoring module;
transmitting the sensor module data to the condition monitoring module via a first, internal interface between the sensor module and the condition monitoring module;
transmitting the data comprising the condition data and/or sensor module data from the condition monitoring module to a circular buffer via a second interface, and temporarily storing the data;
outputting a first trigger signal to the circular buffer via the second interface in dependence on the sensor module data;
after the trigger signal, preventing a further overwriting of the data in the circular buffer for a defined time period; and
outputting data from the circular buffer over a condition data channel.

The invention will be explained in detail in the following with reference to an embodiment and to the drawing. There is shown in the drawing

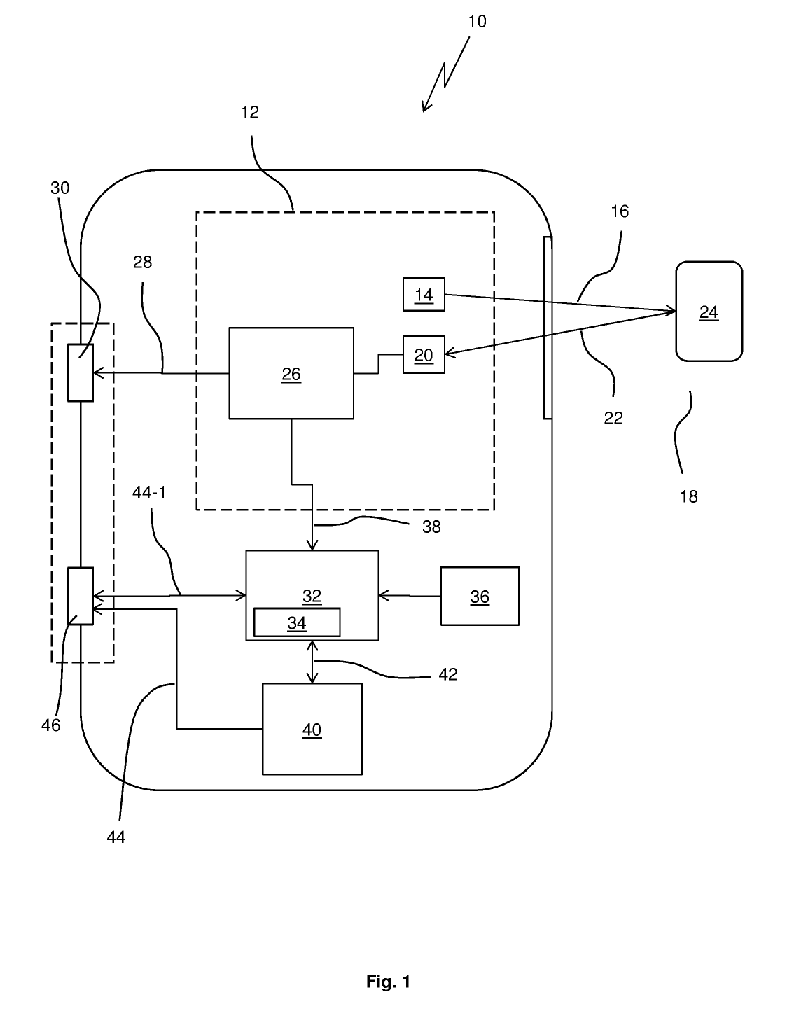

FIG. 1 a schematic representation of a detector in accordance with the invention.

An optoelectronic detector 10 in accordance with the invention has a sensor module 12. The sensor module 12 comprises a light transmitter 14 for transmitting a transmitted light signal 16 into a monitored zone 18; a light receiver 20 for receiving a light signal 22 from the monitored zone 18 and for generating a corresponding received signal. In the embodiment shown, the detector 10 is configured as a light sensor whose transmitted light signal 16 is remitted by an object 24 to be detected in the monitored zone 18. The remitted light is detected as received light 22 by the light receiver 20. A sensor evaluation unit 26 serves for the evaluation of the received signal and for generating an object determination signal from the received signal. The object determination signals are least a proportion of process data and represent the data that the detector 10 delivers in its basic function. The process data can be output over a process data channel 28 to an output 30.

These are the basic functions of known light sensors.

The sensor evaluation unit 26 is further configured to generate and provide sensor module data. Sensor module data can be data that are also generated in to addition to the process data. They can e.g. be the raw signals of the light receiver 20, individual signals of individual light elements of the light receiver, or values derived therefrom such as amplitudes, frequencies, background signals, or other evaluation results.

The detector 10 in accordance with the invention furthermore has a condition monitoring module 32 that itself has a condition evaluation unit 34 for generating condition data. The condition data are either derived from the sensor module data or are pieces of information from third sensors 36 and can comprise pieces of information such as environmental temperature, installation position, power loss, luminous intensity of the environmental light in the monitored zone 18, acceleration of the detector 10, air pressure, electrical or magnetic field strength, or similar parameters. The condition data can also be images of an optical image recorder, e.g. a camera.

A first internal interface 38 is provided between the sensor module 12 and the condition monitoring module 32 to transmit the sensor module data to the condition monitoring module 32.

The detector 10 furthermore has a circular buffer 40 that temporarily stores the data to be stored. The circular buffer 40 is connected via a second interface 42 to the condition monitoring module 32 for this purpose. Only a certain number of data sets are stored in the circular buffer 40, and indeed only so many until it is full. The oldest stored data set is then deleted for every further data set that is then to be stored. Depending on the capacity of the circular buffer 40, a specific number of data sets can thus be stored before the oldest data sets are then overwritten with the newest data sets. Only the latest data sets are thus stored. A data set can comprise the condition data and/or sensor module data.

A numerical example would be that the capacity of the circular buffer 40 is configured such that, for example, all of the data of the third sensors present can be stored every 60 seconds over 24 hours. 1440 data sets are then accrued every 24 h.

The condition monitoring module 32 is furthermore configured to output a first trigger signal via the second interface 42 in dependence on the condition data and/or the sensor module data. The trigger signal prevents a further overwriting of the data in the circular buffer 40 for a defined time period so that the last stored data can be output from the circular buffer 40 over a condition data channel 44 to an outlet 46 and from the detector 10.

A further analysis can then be carried out with these output data. This can, for example, serve the aim of reading and learning the operating conditions at regular time intervals. Or it can serve to analyze an error when the trigger signal is released in response to a single malfunction.

However, the malfunction can actually also comprise the fact that the object determination signal was not triggered. It can therefore be sensible to extract parameters from the sensor module data for the generation of the trigger signal and/or to assess temporal derivations of these parameters and/or statistical features of these parameters. The aim of this evaluation is an increase in the decision confidence in the decision “object present”/“object not present”. A numerical measure of trust can equally be determined from said parameters that indicates how “trustworthy” the current object determination signal is or how probable the switchover actually is into the inverse state “object present”/“object not present”. The numerical measure of trust is also called the quality index. If the measure of trust falls below a settable limit value, the trigger signal can be released.

Examples for events that could release the trigger signal are:
the switching process (off->on or on->off);
especially short switching processes, that is e.g. spikes that can very obviously not be associated with any object 24 since all the objects to be detected are located much longer in the field of view of the detector 10 than the spike duration;
the sensor signal comes close to a switching threshold;
the sensor signal is overmodulated;
redundant signals show a large deviation from one another;
contamination of optical components, in particular of a front screen, are recognized;
the light receiver 20 is optically dazzled by incandescent light or sunlight (“DC overflow”);
the light receiver 20 is optically dazzled by light having a high RF portion (e.g. LED light or light from energy saving lamps) (“AC overflow”);
the light receiver 20 is optically dazzled by a light transmitter of another detector;

and
one of the third sensors 36 such as a temperature sensor, a brightness sensor, or an acceleration sensor reaches a specific value.

Recommended actions derived from these for the user of the detector 10 could be, for example:
if the power consumption differs greatly from the specification, then replace the sensor with a new unit;
if contamination is detected, clean the front screen;
if the position of the sensor has changed, repeat the mechanical adjustment;
if interfering light has been recognized, change the external light sources;
if electrical disruptions have been recognized, check the power pack and the feed lines;
if the extraneous light from other detectors is recognized in the field of view, change the arrangement;
if the received signal progression for the last object was considerably different than with the previous objects, check whether the object was correct or was to be recognized;
if the signal in the detection region briefly increases steeply, but does not result in an object determination, check whether these objects should be recognized or suppressed better than before in future;
if the background changes, check whether this correct and is possible or whether there is an error; and
if unusually large or small signal amplitudes occur on the objects or in the background in some cases, check whether shiny objects are present and whether e.g. a tilt of the sensor avoids such amplitudes.

The condition data sets are advantageously only output as required over the separate condition data channel 44. The output is initiated by the first trigger signal. The condition data channel 44 can transmit the data comparatively slowly since the condition data channel 44 is only used singularly for the analysis.

The condition data from the circular buffer 40 that are output over the condition data channel 44 preferably have a time stamp. This facilitates and improves an error analysis. A counter or a clock is provided in the condition monitoring module 32 for this purpose to be able to generate the time stamp.

In an embodiment of the invention, the condition data set output over the condition data channel 44 includes a piece of information on which of the conditions has released the trigger signal.

In a further development of the invention, the sensor evaluation unit 26 is configured to output a second trigger signal via the first interface to the condition monitoring module in dependence on the sensor module data, said second trigger signal like the first trigger signal then stopping the circular buffer 40 and initiating an output of a condition data set. The sensor evaluation unit 26 can thus itself trigger an acyclic data recording (snapshot). The assumption that the sensor evaluation unit 26 can itself generate a meaningful trigger is based on the experience that the condition of the environment is actually of interest when the detector 10 switches on or off. At this moment, the object 24 to be detected enters into interaction with the detector 10 and is recognized at exactly the right position in the ideal case. In the simplest case, the trigger is released to stop the overwriting in the circular buffer 40 when the object determination signal of the detector 10 just changes its state.

Other triggering conditions are conceivable. The detector 10 can thus have an evaluation unit, not shown, in the sensor evaluation unit 26 that calculates the trigger signal for the condition monitoring module 32 from the detected primary physical parameters (they are naturally the digitized photodiode streams with an optical sensor). This evaluation unit can be specifically implemented for a triangulation light sensor such that the typical distribution of the digitized photodiode streams are determined for non-problematic scanned objects over the working zone of the detector (light spot distribution over the light receiver 20, light spot diameter, sum signal of individual light reception elements of the light receiver 20) and are stored as a reference table in the detector and such that the current distribution of the digitized photodiode streams is compared with the stored data. If the distribution of the digitized photodiode streams deviates in at least one criterion from the reference, the trigger signal is output. Such a typical distribution of the evaluation parameters can either be fixedly stored in the detector (e.g. the dependency of the spot width on the light receiver 20 on the spot position on the light receiver 20) or can be automatically generated during the detector operation. The user can in this manner then determine in which case disruptions of the sensor operation occur from the condition data with implicit knowledge of his application. Such disruptions can e.g. be caused by objects having highly shiny points, objects that have fallen over, that vibrate strongly, or accumulated objects.

In a further development of the invention, the condition monitoring module is programmable over a portion 44-1 of the condition data channel 44 so that the conditions for the output of the first trigger signal can be predefined and set from outside so that the detector 10 works in accordance with predefined criteria. All the detected measurement parameters (of the sensor module 12 and of the condition monitoring module 32) should advantageously be able to be evaluated and logically linked with window comparators for this purpose.

1. An optoelectronic detector for the detection of objects in a monitored zone, the optoelectronic detector comprising
a sensor module comprising a light transmitter configured to transmit a transmitted light signal into the monitored zone, a light receiver configured to receive a light signal from the monitored zone and to generate a corresponding received signal, and a sensor evaluation unit configured to evaluate the received signal and to generate process data and to generate sensor module data;
a process data channel configured to output the process data;
a condition monitoring module having a condition evaluation unit configured to generate condition data;
a first internal interface between the sensor module and the condition monitoring module, the first internal interface being configured to transmit the sensor module data to the condition monitoring module;
a circular buffer that receives data comprising at least one of the condition data and the sensor module data from the condition monitoring module via a second interface, the circular buffer being configured to temporarily store said data comprising at least one of the condition data and the sensor module data;
wherein the condition monitoring module is configured to output a first trigger signal via the second interface in dependence on at least one of the condition data and the sensor module data;
and the first trigger signal prevents a further overwriting of the data in the circular buffer for a defined time period;
and the data from the circular buffer can be output via a condition data channel.

2. The optoelectronic detector in accordance with claim 1, wherein the data from the circular buffer that are output via the condition data channel have a time stamp.

3. The optoelectronic detector in accordance with claim 1, wherein the sensor evaluation unit is configured to output a second trigger signal to the condition monitoring module via the first interface in dependence on the sensor module data.

4. The optoelectronic detector in accordance with claim 1, wherein the sensor evaluation unit is configured to output the second trigger signal when the object determination signal changes.

5. The optoelectronic detector in accordance with claim 1, wherein the condition monitoring module is configured to output the first trigger signal if one of the following conditions is satisfied:
if the signal progression of the received signal significantly differs from the previous signal progressions;
if the amplitude of the received signal or of the evaluated received signal varies by more than a defined value within a defined time period,
if the amplitude of the received signal or of the evaluated received signal is within a defined value range;
if particularly short switching processes are detected that are so short that they cannot be associated with an object;
if the received signal comes close to a predefined switching threshold;
if the received signal is overmodulated;
if redundant signals show large deviations;
if a contamination of optical components is recognized;
if a dazzling of the light receiver is recognized; or
if the detector recognizes interference by another, adjacent detector of the same construction.

6. The optoelectronic detector in accordance with claim 5, wherein the evaluated received signal is a difference signal.

7. The optoelectronic detector in accordance with claim 1, wherein the condition monitoring module is configured to determine a quality index and outputs the first trigger signal when the quality index is in a predefined range.

8. The optoelectronic detector in accordance with claim 5, wherein the data from the circular buffer that are output over the condition data channel include a piece of information on which condition has released the trigger signal.

9. The optoelectronic detector in accordance with claim 7, wherein the data from the circular buffer that are output over the condition data channel include a piece of information on which condition has released the trigger signal.

10. The optoelectronic detector in accordance with claim 1, wherein the condition monitoring module is programmable over the condition data channel so that the conditions for the output of the first trigger signal can be set.

11. The optoelectronic detector in accordance with claim 1, wherein the detector has third sensors whose third sensor data are evaluated by the condition monitoring module to generate the first trigger signal.

12. The optoelectronic detector in accordance with claim 1, wherein a camera is provided whose image recording is released by the first or second trigger signals.

13. A method of detecting objects in a monitored zone, the method comprising the steps of:
transmitting a transmitted light signal by a light transmitter into the monitored zone, receiving a light signal by a light receiver from the monitored zone, and generating a corresponding received signal and evaluating the received signal, generating process data, and generating sensor module data using a sensor data evaluation unit;
outputting the process data over a process data channel;
generating condition data using a condition evaluation unit in a condition monitoring module;
transmitting the sensor module data to the condition monitoring module via a first, internal interface between the sensor module and the condition monitoring module;
transmitting the data comprising the condition data and/or sensor module data from the condition monitoring module to a circular buffer via a second interface, and temporary storing of the data;
outputting a first trigger signal to the circular buffer via the second interface in dependence on the sensor module data;
after the trigger signal, preventing a further overwriting of the data in the circular buffer for a defined time period; and
outputting data from the circular buffer over a condition data channel.
